(19) United States
(12) Patent Application Publication
(10) Pub. No.: US 2009/0046680 A1
(43) Pub. Date: Feb. 19, 2009

(54) DATA TRANSMISSION SYSTEM FOR WIRELESS LOCAL AREA NETWORK AND METHOD THEREOF

(75) Inventor: Chang Keun SEO, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/136,162

(22) Filed: Jun. 10, 2008

(30) Foreign Application Priority Data
Aug. 14, 2007 (KR) 2007-81956

(51) Int. Cl. H04Q 7/24

(52) U.S. Cl. 370/338

(57) ABSTRACT

A station transmit data to another station positioned outside its regulatory maximum transmit power via an access point according to a method defined in an infrastructure mode and directly transmit data to another positioned within a range of its regulatory maximum transmit power according to a method defined in a direct transmission mode.

### CROSS-REFERENCE TO RELATED APPLICATIONS

This application claims priority under 35 U.S.C. 119(a) from Korean Patent Application No. 2007-81956, filed on Aug. 14, 2007 in the Korean Intellectual Property Office, the disclosure of which is incorporated herein in its entirety by reference.

### BACKGROUND OF THE INVENTION

1. Field of the Invention

The present general inventive concept relates to a data transmission system usable with a wireless local area network (LAN) and a method thereof, which are capable of transmitting data between stations.

2. Description of the Related Art

The wireless LAN is a scheme for performing communication over a network using a radio wave, without using cable. The wireless LAN emerged as an alternative for solving difficulties of installation, maintenance and movement of communication equipment due to cabling, and its use is on the increase since the number of mobile users is increasing.

The wireless LAN is classified into two modes: an infrastructure mode which is a wireless LAN with an access point (AP) and an ad-hoc mode which is a wireless LAN without the AP.

Since the infrastructure mode can be connected to the external Internet and can reliably perform communication under the control of the AP, the infrastructure mode can be more widely used compared with the ad-hoc mode.

In the infrastructure mode, the AP manages a data transmission schedule in order to connect the wireless LAN to a wired network or perform wireless communication between devices in the wireless LAN. Accordingly, all wireless network devices can transmit/receive data via a channel allocated by the AP.

When a wireless LAN user associates a station including a wireless LAN card, such as a notebook computer, a personal digital assistant (PDA), or an image forming apparatus, with an AP mounted in a hot-spot area, a wireless LAN service can be received.

FIG. 1 is a view illustrating a conventional data transmission system for a wireless LAN.

The data transmission system for the wireless LAN may include an AP 10 and first to third stations 30, 40 and 50. The first to third stations may be a personal computer (PC) 30, a printer A 40 and a printer 50, respectively. The AP 10 is connected to a wired network 20.

The first to third stations 30, 40 and 50 are positioned within a range of a regulatory maximum transmit power RMTP1 of the AP 10.

The AP 10 is positioned at an intersection of the respective regulatory maximum transmit powers RMTP2, RMTP3 and RMTP4 of the first to third stations 30, 40 and 50.

The second station 40 is positioned outside the range of the regulatory maximum transmit power RMTP2 of the first station 30 and the third station 50 is positioned within the range of the regulatory maximum transmit power RMTP2.

In the data transmission system for the wireless LAN using the infrastructure mode, since data should be transmitted to another station via the AP, the first station 30 transmits data to the second station 40 via the AP 10 and transmits data to the third station 50 via the AP 10.

In the infrastructure mode, the data is transmitted between the stations through the AP by two methods.

As a transmission method, a procedure of transmitting data from the first station 30 to the second station 40 which is positioned outside the range of the regulatory maximum transmit power of the first station will be described.

The first station 30 transmits a request-to-send (RTS) frame to the AP 10 and the AP 10 transmits a clear-to-send (CTS) frame responding thereto to the first station 30, in order clear a medium in the regulatory maximum transmit power of the first station. Accordingly, since only the first station 30 can transmit data in the medium, the first station 30 transmits the data to the AP 10. The AP 10 receives the data and then transmits an acknowledge signal ACK.

In the infrastructure mode, a distributed coordination function (DCF) scheme using a random back-off algorithm is used to reduce a data collision probability. At this time, a plurality of stations contend in order to acquire a data transmission right with the AP in a contention period (CP).

When the transmission right is given to the second station 40, the AP 10 transmits a RTS frame to the second station 40 and the second station 40 transmits a CTS frame responding thereto to the AP 10, in order to clear a medium. Accordingly, since only the second station 40 can transmit data in the medium, the AP 10 transmits the data transmitted from the first station to the second station 40. Then, the second station 40 receives the data and then transmits an acknowledge signal ACK.

As another transmission method, a procedure of transmitting data from the first station to the third station 50 positioned within the range of the regulatory maximum transmit power of the first station will be described.

In this method, as described above, a procedure of clearing the medium is omitted and the first station 30 transmits the data to the AP 10.

At this time, when the third station 50 acquires the contention right in the CP, the AP 10 transmits the data received from the first station to the third station 50. The third station 50 receives the data and then transmits an acknowledge signal ACK.

In the existing infrastructure mode, the data should be transmitted from a station to another station via the AP. Accordingly, even when a station transmits data to another station positioned within the range of its regulatory maximum transmit power, the data is transmitted via the AP. At this time, the transmission procedure becomes complicated and the stations should contend in order to acquire the data transmission right from the AP in the CP.

Meanwhile, the stations may include both the infrastructure mode and the ad-hoc mode and may transmit data in any one of the two modes. In this case, the station should include a program for the plurality of modes and should perform a complicated process to select the mode.

### SUMMARY OF THE INVENTION

The present general inventive concept provides a data transmission system usable with a wireless LAN and a method thereof, which are capable of simplifying a data transmission procedure so as to improve data transmission efficiency while maintaining advantages of an infrastructure mode.

Additional aspects and/or advantages of the present general inventive concept will be set forth in part in the description which follows and, in part, will be obvious from the description, or may be learned by practice of the general inventive concept.

The foregoing and/or other aspects of the present general inventive concept can be achieved by providing a data transmission system usable with a wireless local area network (LAN), the system including an access point to control wireless communication between a plurality of stations, and at least one station which is connected to the access point and is restrictively operated in an infrastructure mode for data transmission.

The at least one station may be operated in the infrastructure mode when transmitting data to another station positioned outside a range of a regulatory maximum transmit power of the at least one station.

The at least one station may restrict the infrastructure mode in order to directly transmit the data to another station positioned within a range of a regulatory maximum transmit power of the at least one station.

The at least one station may set an address field of a medium access control (MAC) header included in a frame for data transmission in order to restrict the infrastructure mode.

The at least one station may set information for the access point of information of the address field included in the frame such that the data cannot be received and set information for another station positioned within the range of the regulatory maximum transmit power of the at least one station such that the data can be received.

The at least one station may transmit a request-to-send (RTS) frame to the access point and receive a clear-to-send (CTS) frame from the access point in order to clear a medium as a preparing procedure before directly transmitting the data to another station.

The at least one station may transmit the data after determining whether another station can receive the data, in order to prevent data collision.

The at least one station may determine whether another station can receive the data, depending on data exchanged between another station and the access point positioned within the range of the regulatory maximum transmit power of the at least one station and information included in a RTS frame and a CTS frame.

The foregoing and/or other aspects and utilities of the present general inventive concept may also be achieved by providing a wireless LAN data transmission method of wirelessly communicating between a plurality of stations using an access point, the method including determining whether a counterpart station to receive data from at least one station is positioned within a range of a regulatory maximum transmit power of the at least one station, and directly transmitting the data from the at least one station to the counterpart station without passing via the access point if the counterpart station is positioned within the range of the regulatory maximum transmit power of the at least one station.

If the at least one station directly transmits the data to the counterpart station, information of an address field of a MAC header included in a frame for data transmission may be set.

The at least one station may transmit a request-to-send (RTS) frame to the access point and receive a clear-to-send (CTS) frame from the access point in order to clear a medium before directly transmitting the data.

The at least one station may transmit the data to the counterpart station after determining whether the counterpart station can receive the data, in order to prevent data collision.

The at least one station may determine whether another station can receive the data, depending on data exchanged between another station and the access point in the regulatory maximum transmit power of the at least one station and information included in a RTS frame and a CTS frame.

The foregoing and/or other aspects and utilities of the present general inventive concept may also be achieved by providing a data transmission system usable with a wireless local area network (LAN), the system including a station wirelessly connected to an access point and an other station, to transmit data to the other station through the access point, and to directly transmit data to the other station according to a determination of whether the other station is in a range to receive the data.

The station may transmit the data to the other station through the access point when the other station is outside the range.

The station may transmit the data to the other station through the access point when the other station is outside the range.

The range may be a range of a regulatory maximum transmit power of the station, and the other station may be located in the range to be reachable from the station to exchange the data.

The station may directly transmit the other station without through the access point according to the determination of whether the other station is in a range to receive the data.

The station may communicate with the access points to obtain information on the other station, and communicate with the other station according to the information to transmit the data without using the access point.

The station may transmit a signal to other station, and the other station directly transmits response to the station such that the station determines that the other station is within the range and transmits the data to the other station according to the determination.

The foregoing and/or other aspects and utilities of the present general inventive concept may also be achieved by providing a method of a data transmission system usable with a wireless local area network (LAN), the method including wirelessly connecting a station to an access point and an other station, transmitting data to the other station through the access point, and directly transmitting data to the other station according to a determination of whether the other station is in a range to receive the data.

The foregoing and/or other aspects and utilities of the present general inventive concept may also be achieved by providing a computer-readable medium to contain computer-readable codes as a program to execute a method of data transmission system usable with a wireless local area network (LAN), the method including wirelessly connecting a station to an access point and an other station, transmitting data to the other station through the access point, and directly transmitting data to the other station according to a determination of whether the other station is in a range to receive the data.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating a conventional data transmission system usable with a wireless LAN;

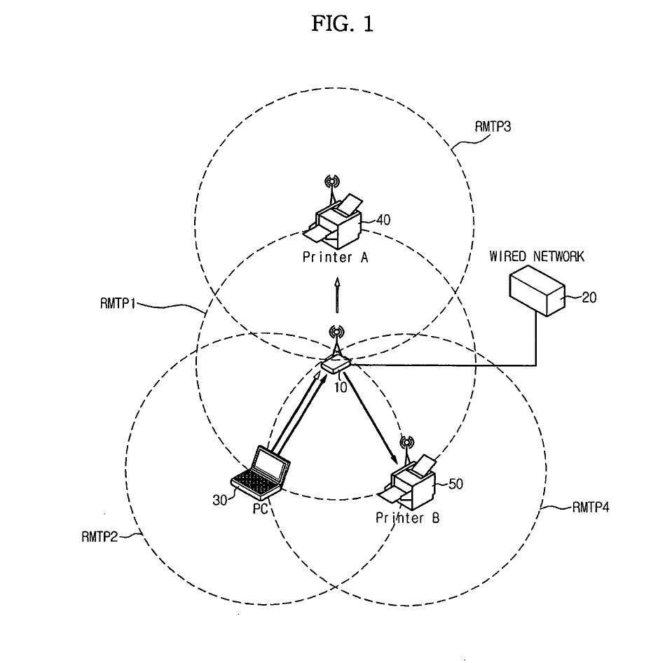

FIG. 2 is a view illustrating an operation to allow a station to transmit data to another station positioned outside its regulatory maximum transmit power using a method of clearing a medium in an infrastructure mode;

FIG. 3 is a view illustrating an operation to allow a station to transmit data to another station positioned within a range of its regulatory maximum transmit power in an infrastructure mode;

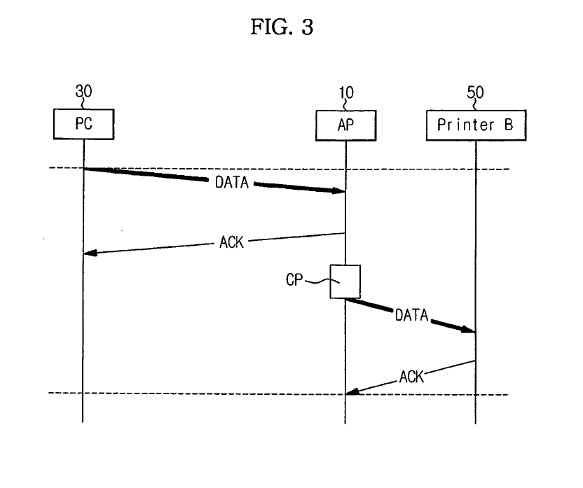

FIG. 4 is a view illustrating a data transmission system usable with a wireless LAN according to an embodiment of the present general inventive concept;

FIG. 5 is a detailed view illustrating a first station of FIG. 4;

FIG. 6 is a view illustrating a frame to be transmitted according to an infrastructure mode;

FIG. 7 is a view illustrating a setting state of fields of a frame applied when a station transmits data to another station positioned outside its regulatory maximum transmit power via an access point (AP) in a data transmission system usable with a wireless LAN according to an embodiment of the present general inventive concept;

FIG. 8 is a view illustrating a setting state of fields of a frame applied when a station transmits data to another station positioned outside its regulatory maximum transmit power without passing via an AP in a data transmission system usable with a wireless LAN according to an embodiment of the present general inventive concept;

FIG. 9 is a view illustrating an operation to allow a station to transmit data to another station positioned within a range of its regulatory maximum transmit power in a data transmission system usable with a wireless LAN according to an embodiment of the present general inventive concept; and

FIG. 10 is a view illustrating an operation to allow a station to transmit data to another station positioned within a range of its regulatory maximum transmit power in a data transmission system usable with a wireless LAN according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below to explain the present general inventive concept by referring to the figures.

Hereinafter, a data transmission system usable with a wireless LAN and a method thereof will be described.

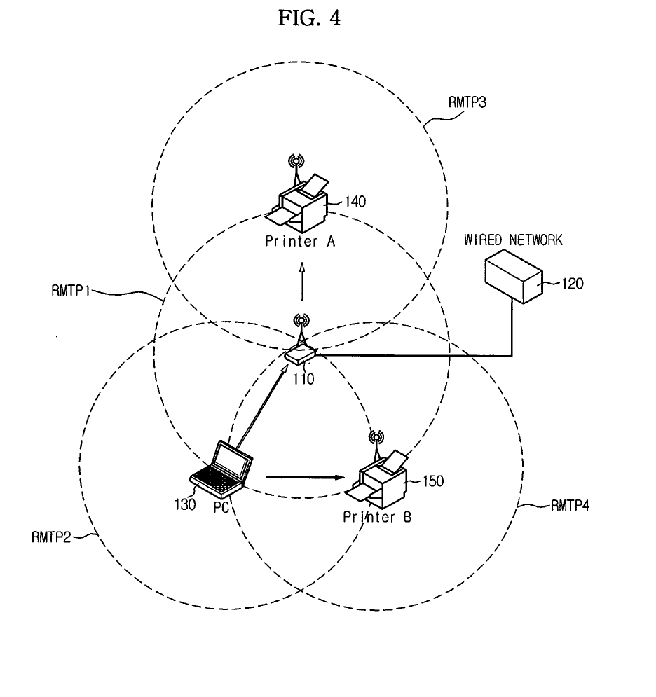

FIG. 4 is a view illustrating a data transmission system usable with a wireless LAN according to an embodiment of the present general inventive concept.

As illustrated in FIG. 4, the data transmission system usable with the wireless LAN according to an embodiment of the present general inventive concept includes an access point (AP) 110 and first, second, and third stations 130, 140 and 150. The first, second, and third stations may be a personal computer (PC) 130, a printer A 140 and a printer B 150, respectively. However, the present general inventive concept is not limited thereto. Other apparatus with a wireless communication unit can be used as the first, second, and third stations. The AP 110 is connected to a wired network 120.

The first, second, and third stations 130, 140 and 150 are positioned within a range of a regulatory maximum transmit power RMTP1 of the AP 110. The AP 110 may be positioned at an intersection of the respective regulatory maximum transmit powers RMTP2, RMTP3 and RMTP4 of the first, second, and third stations 130, 140 and 150.

The second station 140 is positioned outside the range of the regulatory maximum transmit power RMTP2 of the first station 130 and the third station 150 is positioned within the range of the regulatory maximum transmit power RMTP2.

In the present embodiment, a method of transmitting data in an infrastructure mode and a method of directly transmitting data between the stations are selectively used. In order to allow a station to transmit data to another station positioned outside its regulatory maximum transmit power, the data is transmitted via the AP according to a method of transmitting data in the infrastructure mode. In order to allow a station to transmit data to another station positioned within the range of its regulatory maximum transmit power, the data is directly transmitted between the stations according to a method of directly transmitting data between stations in a direct transmitting mode.

For example, the first station 130 transmits data to the second station 140 via the AP 110. Alternatively, the first station 130 may transmit data to the third station 150 without passing via the AP 110, because the third station 150 is positioned within the range of the regulatory maximum transmit power RMTP2 of the first station 130 and thus an environment where data can be communicated is established.

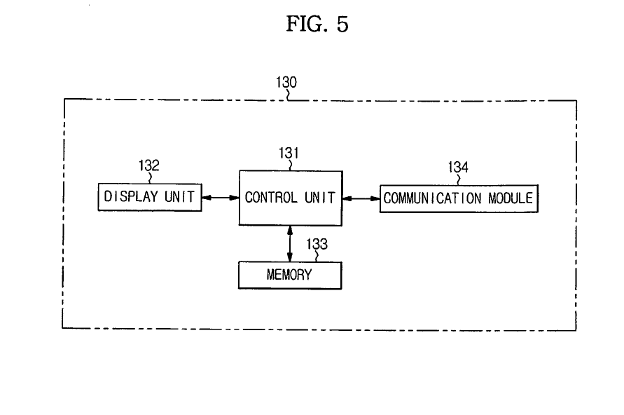

The first, second, and third stations 130, 140 and 150 can selectively use a plurality of data transmission methods. The detailed configuration of the first station 130 will be described in detail with reference to FIG. 5.

The first station 130 includes a control unit 131, a display unit 132, a memory 133 and a communication module 134.

The communication module 134 indicates a wireless LAN card to allow a station to transmit and/or receive data another station or an AP in its regulatory maximum transmit power.

The control unit 131 reads information for data transmission from the memory 133, generates a frame for data transmission, and transmits the frame for data transmission to the AP 110 or another station positioned within the range of its regulatory maximum transmit power via the communication module 134. Here, the information for data transmission may be information on data to be transmitted, or may be data to be transmitted.

The control unit 131 transmits the frame to a corresponding station via the AP 110 when performing data communication with the station positioned outside its regulatory maximum transmit power, and directly transmits the frame to a corresponding station without passing via the AP 10 when performing data communication with the station positioned within the range of its regulatory maximum transmit power. When the first, second, and third stations 130, 140 and 150 perform data communication without passing via the AP, in order to prevent data collision or reduce data traffic congestion, the data is transmitted after determining whether a counterpart station can receive the data. The determination of whether the counterpart station can receive the data is made depending on data exchanged between another station and the AP in the regulatory maximum transmit power of a transmission station and information included in a RTS frame and a CTS frame.

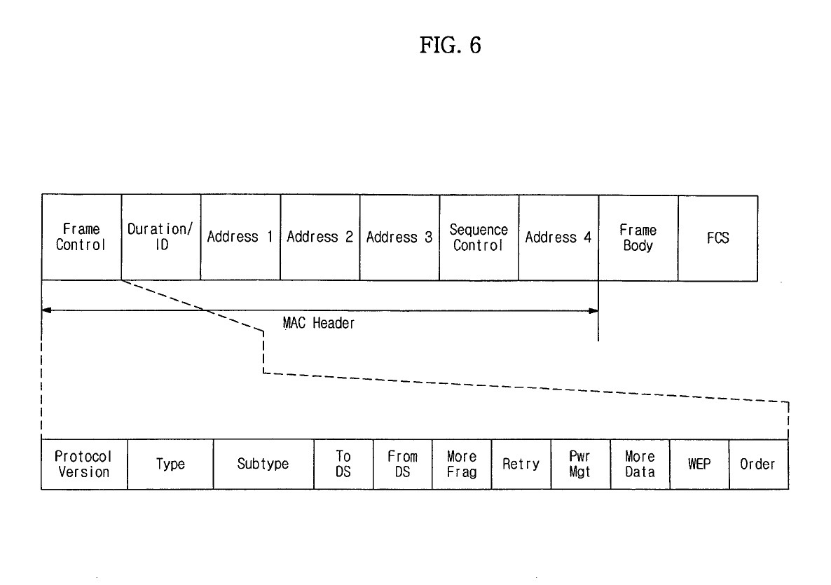

The frames used in the stations have the same frame format used in an infrastructure as illustrated in FIG. 6 and may be used in a medium access control (MAC) layer.

This frame format includes a MAC header including a frame control field, a duration/ID field, four address fields Address 1, Address 2, Address 3 and Address 4 and a sequence control field, a frame body, and a frame check sequence.

The frame control field includes a protocol version, a type field, a subtype field, a “To DS” field, a “from DS” field, a more frag bit, a retry bit, a Pwr Mgt bit, a more data bit, a WEP bit, and an order bit.

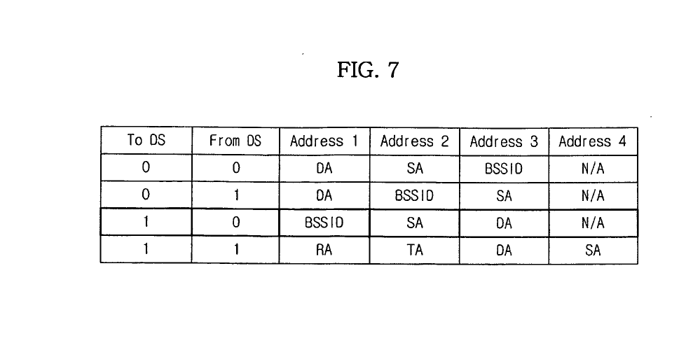

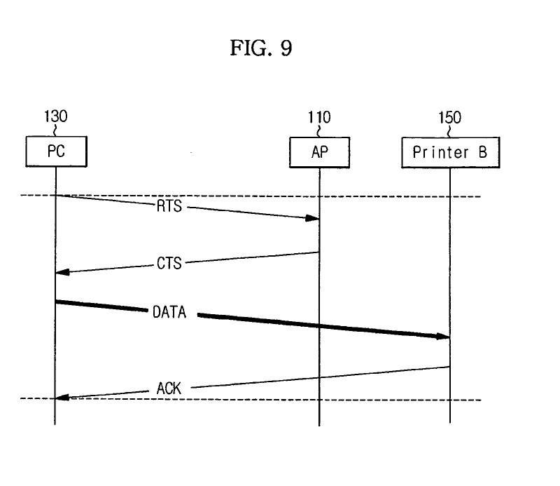

As described above, each of the first, second, and third stations 130, 140 and 150 transmits data according to a method illustrated in FIG. 9 using the frame generated based on information set with respect to fields of the frame as illustrated in FIG. 7, when transmitting data to another station positioned outside its regulatory maximum transmit power.

Referring to FIG. 7, the “To DS” field and the “from DS” field are respectively 1 and 0, the third address field Address 3 is set to DA, and the fourth address field Address 4 is set to N/A. If the frame having the first and fourth address fields shown in FIG. 7 is transmitted to any station at the time of data transmission, the AP 110 receives the frame because the third address field Address 3 is set to DA, but another station does not receive the frame because the fourth address field Address 4 is set to N/A and it is determined that the medium is in a busy state.

Also referring to FIG. 7, the first address filed Address 1 is set to BSSID, and the second address field Address 2 is set to SA. Here, BSSID stands for basic service set identification to identify a group of stations controlled by an AP and/or to distinguish a station from other stations, SA stands for source address to indicate an address, for example, 48 bits of IEEE 802 MAC Address, of a station transmitting data as a frame in a MAC layer, DA stands for destination address to indicate an address, for example, 48 bits of IEEE 802 MAC Address, of a station receiving data, N/A stands for not applicable, and DS stands for distribution system to represent formation of a larger communication network by connecting a wireless network and a wired network.

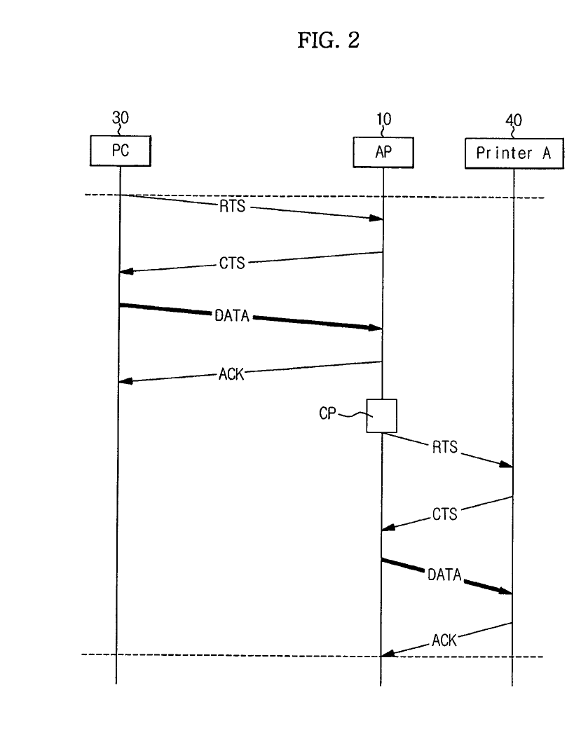

Thereafter, the AP 110 transmits the data to a station positioned outside the range of the regulatory maximum transmit power of the transmission station as a station acquiring a transmission right in a contention period. Such data transmission may use a method of FIG. 2 or a method of FIG. 9.

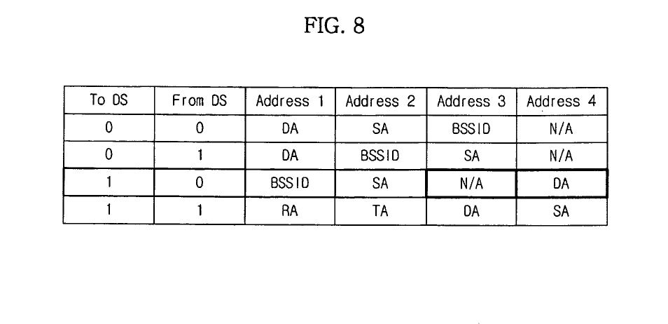

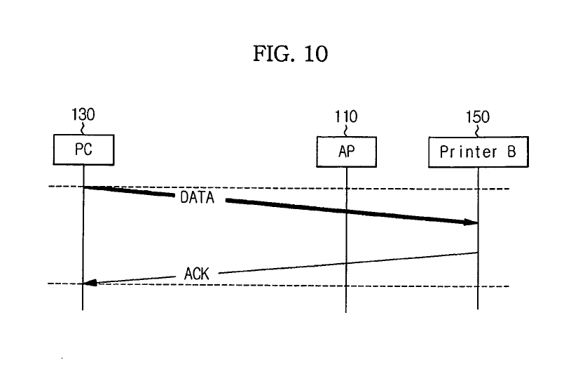

Meanwhile, each of the first to third stations 130, 140 and 150 transmits data according to a method illustrated in FIG. 9 or 10 using the frame generated based on information of FIG. 8 set with respect to fields of the frame, when transmitting data to another station positioned within the range of its regulatory maximum transmit power.

FIG. 8 illustrates the information on the fields of the frame to be used to transmit and receive data.

Referring to FIG. 8, the “To DS” field and the “from DS” field are respectively 1 and 0, the third address field Address 3 is set to N/A, and the fourth address field Address 4 is set to DA. If the frame having the third and fourth address fields is transmitted to any station at the time of data transmission, the AP 110 does not receive the frame because the third address field Address 3 is set to DA and it is determined that the AP 110 is in a busy state, and another station positioned within the range of the regulatory maximum transmit power of the transmission station receives the frame because the fourth address field Address 4 is set to DA.

Also referring to FIG. 8, the first address filed Address 1 is set to BSSID, and the second address field Address 2 is set to SA.

The present general inventive concept provides a method of directly transmitting data to a counterpart station positioned within the range of a regulatory maximum transmit power of a transmission station without passing via the AP after the transmission station performs an operation with respect to the AP as a preparing procedure before direct data transmission to the counterpart station without using the AP.

As illustrated in FIG. 9, the first station 130 transmits a request-to-send (RTS) frame to the AP 110 and the AP 110 transmits a clear-to-send (CTS) frame responding thereto to the first station 130, in order to clear a medium in the regulatory maximum transmit power of the first station 130. Accordingly, only the first station 130 can receive the data in the medium. Thereafter, the first station 130 transmits the frame generated based on the information of FIG. 8 to the third station 150 positioned within the range of the regulatory maximum transmit power of the first station 130. The third station 150 receives the data and then transmits an acknowledge signal ACK.

The preparing procedure, which is performed before data transmission, may be omitted and the transmission station may directly transmit the data to the counterpart station positioned within the range of the regulatory maximum transmit power of the transmission station.

As illustrated in FIG. 10, the first station 130 determines whether the counterpart station can receive the data and then transmits the frame generated based on the information of FIG. 8 to the third station 150 positioned within the range of the regulatory maximum transmit power of the first station 130. The third station 150 receives the data from the first station 130 and then transmits an acknowledge signal ACK to the first station 130. Here, the determination of whether the counterpart station can receive the data can be made depending on data exchanged between the counterpart station and the AP in the regulatory maximum transmit power of the transmission station and information included in a RTS frame and a CTS frame as information acquired via the communication module.

For example, when the first station 130 communicates with the AP, the AP may communicate with the third station 150 such that the third station 150 is ready to receive data from the first station 130. When the AP determines whether the counter part station is located within a range of the regulatory maximum transmit power of the first station 130, the AP transmits information on the determination to the first station 130 and/or the third station 150. When the first station 130 determines whether the counterpart station is located within a range of the regulatory maximum transmit power of the first station, the AP or the first station 130 may transmit information on the determination to the AP and/or the third station 150.

It is possible to determine whether the counterpart station can receive the data or whether the counter part station is located within a range of the regulatory maximum transmit power of the first station, according to previously stored information on locations or distances of respective stations. It is also possible to determine whether the counterpart station can receive the data or whether the counter part station is located within a range of the regulatory maximum transmit power of the first station, according to communications from the first station to the other stations and the AP to exchange data on the locations or distances with respect to the first station and/or the AP.

When the first station 130 transmits a signal, e.g., the frame, to locate one or more stations and/or an AP which might be disposed in a reachable distance or location in a range of the regulatory maximum transmit power of the first station 130, the stations and/or the AP may respond to the first station 130 such that the first station 130 can directly transmit data to the counterpart station, and the counterpart station prepares to directly receive data from the first station 130.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, since a station can transmit data to another positioned within the range of its regulatory maximum transmit power, it is possible to reduce a data transmission procedure compared with a case of necessarily transmitting data via an access point and improve transmission efficiency by the simplification of the procedure.

Accordingly, it is possible to reduce a data transmission procedure compared with a case of transmitting data via an access point and to improve transmission efficiency by the simplification of the procedure.

Although a few embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. A data transmission system usable with a wireless local area network (LAN), the system comprising:
an access point to control wireless communication between a plurality of stations; and
at least one of the stations which is connected to the access point and is restrictively operated in an infrastructure mode for data transmission.

2. The data transmission system of claim 1, wherein the at least one station is operated in the infrastructure mode when transmitting data to another station positioned outside a range of a regulatory maximum transmit power of the at least one station.

3. The data transmission system of claim 1, wherein the at least one station restricts the infrastructure mode in order to directly transmit the data to another station positioned within a range of a regulatory maximum transmit power of the at least one station.

4. The data transmission system of claim 3, wherein the at least one station sets an address field of a medium access control (MAC) header included in a frame for data transmission in order to restrict the infrastructure mode.

5. The data transmission system of claim 4, wherein the at least one station sets information for the access point of information of the address field included in the frame such that the data cannot be received and sets information for another station positioned within the range of the regulatory maximum transmit power of the at least one station such that the data can be received.

6. The data transmission system of claim 3, wherein the at least one station transmits a request-to-send (RTS) frame to the access point and receives a clear-to-send (CTS) frame from the access point in order to clear a medium as a preparing procedure before directly transmitting the data to another station.

7. The data transmission system of claim 3, wherein the at least one station transmits the data after determining whether another station can receive the data, in order to prevent data collision.

8. The data transmission system of claim 7, wherein the at least one station determines whether another station can receive the data, depending on data exchanged between another station and the access point positioned within the range of the regulatory maximum transmit power of the at least one station and information included in a RTS frame and a CTS frame.

9. A wireless LAN data transmission method of wirelessly communicating between a plurality of stations using an access point, the method comprising:
at least one station determining whether a counterpart station which will receive data is positioned within a range of a regulatory maximum transmit power of the at least one station; and
the at least one station directly transmitting the data to the counterpart station without passing via the access point if the counterpart station is positioned within the range of the regulatory maximum transmit power of the at least one station.

10. The wireless LAN data transmission method of claim 9, wherein, if the at least one station directly transmits the data to the counterpart station, information of an address field of a MAC header included in a frame for data transmission is set.

11. The wireless LAN data transmission method of claim 9, wherein the at least one station transmits a request-to-send (RTS) frame to the access point and receives a clear-to-send (CTS) frame from the access point in order to clear a medium before directly transmitting the data.

12. The wireless LAN data transmission method of claim 9, wherein the at least one station transmits the data to the counterpart station after determining whether the counterpart station can receive the data, in order to prevent data collision.

13. The wireless LAN data transmission method of claim 12, wherein the at least one station determines whether another station can receive the data, depending on data exchanged between another station and the access point in the regulatory maximum transmit power of the at least one station and information included in a RTS frame and a CTS frame.

14. A data transmission system usable with a wireless local area network (LAN), the system comprising:
a station wirelessly connected to an access point and an other station, to transmit data to the other station through the access point, and to directly transmit data to the other station according to a determination of whether the other station is in a range to receive the data.

15. The data transmission system of claim 14, wherein the station transmits the data to the other station through the access point when the other station is outside the range.

16. The data transmission system of claim 14, wherein:
the range is a range of a regulatory maximum transmit power of the station; and
the other station is located in the range to be reachable from the station to exchange the data.

17. The data transmission system of claim 14, wherein the station directly transmits the other station without through the access point according to the determination of whether the other station is in a range to receive the data.

18. The data transmission system of claim 14, wherein the station communicates with the access points to obtain information on the other station, and communicates with the other station according to the information to transmit the data without using the access point.

19. The data transmission system of claim 14, wherein the station transmits a signal to other station, and the other station directly transmits response to the station such that the station determines that the other station is within the range and transmits the data to the other station according to the determination.
